(19) United States
(12) Patent Application Publication
(10) Pub. No.: US 2003/0066677 A1
(43) Pub. Date: Apr. 10, 2003

(54) Busbar system for lights

(76) Inventor: Hans-Walter Hustadt, Arnsberg (DE)

Correspondence Address: Gregory P. LaPointe, BACHMAN & LaPOINTE, P.C., Suite 1201, 900 Chapel Street, New Haven, CT, 06510-2802, US

(21) Appl. No.: 10/187,170

(22) Filed: Jun. 27, 2002

(30) Foreign Application Priority Data
Oct. 5, 2001 (DE) 201 16 392.6
Apr. 9, 2002 (DE) 202 05 511.6

(51) Int. Cl. H01B 17/00

(52) U.S. Cl. 174/149 B

(57) ABSTRACT

A busbar system for lights, especially a high voltage busbar system, comprising at least one resilient busbar which has supply lines (1) which are surrounded by a resilient strip-like insulating material (2), the busbar system further comprising at least one adaptor unit (4, 34) which has contact elements (18, 38) that reach through the strip-like insulating material (2) to make electrically conductive contact with the supply lines (1), and also a connecting region for the connection to at least one lamp (5), wherein the busbar system further comprises a preferably flexible concealment device (3, 8, 21) which surrounds the strip-like insulating material (2), at least in some sections.

### BACKGROUND OF THE INVENTION

The present invention relates to a busbar system for lights, especially a high voltage busbar system, comprising at least one resilient busbar which has supply lines which are surrounded by a resilient strip-like insulating material, the busbar system further comprising at least one adaptor unit which has contact elements that reach through the strip-like insulating material to make electrically conductive contact with the supply lines, and also a connecting region for the connection to at least one lamp. Furthermore, the present invention relates to such a busbar system which, according to the preamble of claim 2, does not comprise a strip-like insulating material.

Busbar systems of the type mentioned at the beginning are well known, in particular from the outdoors sector. The resilient busbars used in this case are generally a plastic material which is injection molded around two supply lines. Because of its material characteristics, the resilient busbars from the prior art have an exceptionally unattractive and, for the major part, even porous surface. For this reason, the busbar systems of the type mentioned at the beginning are used only in the outdoors sector, for example in garden parties or the like, for example draped in bushes or trees.

The problem on which the present invention is based is to provide a busbar system of the type mentioned at the beginning which provides an optically appealing exterior and is flexible.

### SUMMARY OF THE INVENTION

According to the invention, this is achieved by the busbar system further comprising a preferably flexible concealment device which surrounds the strip-like insulating material and/or the supply lines, at least in some sections. As the result of the use of such a concealment device, the optically less appealing exterior of the strip-like insulating material or of the supply lines can be concealed, so that the busbar is enhanced considerably with regard to its appearance.

In the embodiment without strip-like insulating material, preferably integrally molded holding grooves for the supply lines can be provided on the inside of the concealment device. These holding grooves provide a simple and effective possible connection between supply lines and concealment device.

Here, the strip-like insulating material can be substantially completely surrounded by the concealment device. This measure means that the tasteful impression of the busbar system is determined only by the concealment device and also the adaptor unit and the lamps fixed thereto, but not by the strip-like insulating material.

According to a preferred embodiment of the present invention, the concealment device can be coated on its outer side, in particular with a metallic coating. Any desired materials can be simulated by such a coating. In particular, brass-like, chromium-like or titanium-like surfaces can be created by means of appropriate coatings, which optically enhance the exterior of the busbar system.

According to a preferred embodiment of the present invention, provision is made for the concealment device to be capable of being removed from the strip-like insulating material and/or the supply lines and transferred into a flat spread-out form. The possibility of removing the concealment device means that concealment devices can simply be changed, so that the external impression produced by the busbar system can be adapted as desired to the market requirements.

In particular, in this case the concealment device can be rolled up when it is removed. In this way, the concealment device can be stored in an extremely small space. This has in particular the advantage that the entire busbar system, which comprises the strip-like insulating material and/or the supply lines, the adaptor units and the lamps and the concealment device can be introduced into very small, easily transportable and also easily presentable packaging units.

According to an alternative embodiment, the concealment device can be formed as a rod material that is flexible, at least in some sections.

In this case, the concealment device can be closed around the strip-like insulating material and/or around the supply lines, from the flat state, by folding around a hinge, in particular a film hinge. Alternatively, the concealment device can comprise two halves, which can be connected to each other around the strip-like insulating material and/or the supply lines. In both cases, the result on site for the user is a mounting of the busbar system which can be carried out very easily.

According to a preferred embodiment of the present invention, passage openings for the contact elements are provided on the outer side of the concealment device. These passage openings enable contact to be made with the supply lines without the concealment device being damaged in the process.

The contact elements are advantageously surrounded by insulating rings, which can engage in the passage openings in such a way that the contact elements can be led through the passage openings while being electrically insulated from the concealment device. Insulating the contact elements with respect to the concealment device avoids the individual contact elements being connected electrically to one another, for example by a metallic coating of the concealment device, there then being the risk of a short circuit.

According to the invention, provision can be made for the adaptor unit to have a body with a recess, into which the busbar can be introduced, the contact elements projecting from the body into this recess. In this case, the adaptor unit can comprise a cover which, when it is fitted and fixed to the body, can ensure the making of reliable contact with a busbar introduced into the recess. As a result of this measure, by means of simple insertion of the busbar into the recess and corresponding, for example, pressing and latching of the cover, contact can be made between the supply lines and the contact elements.

According to an alternative embodiment of the present invention, the adaptor unit comprises a body with two halves that can be connected to each other, between which the recess can be formed. In this way, too, simple and secure fitting and making of contact with a busbar introduced into the recess can be ensured.

Provision can preferably be made in this case for the adaptor unit to comprise a cover plate which has slots for the passage of the contact elements. This cover plate can be used firstly for stabilization and secondly for protection of the contact elements.

According to the invention, there is furthermore the possibility that concealment elements are provided which are able to conceal individual parts of the busbar system. The concealment elements may be firstly adaptor concealments which are able to conceal adaptors. Secondly, the concealment elements can also be used to conceal ceiling supports or feed lines. These concealment elements can be provided with different decorations, so that as a result the optical impression of the appropriate parts to be concealed can be varied in a simple way.

Here, there is the possibility that the concealment elements can be clipped onto the parts of the busbar system to be concealed or latched thereto. In this way, using extremely simple means, the appearance of various parts of the busbar system can be changed within an extremely short time.

According to the invention, provision can be made for the busbar system to comprise at least one end piece, which can be fitted to one end of the busbar, in particular screwed thereto. In this case, a decorative cap can be pushed onto the end piece. The end piece ensures that the supply lines, carrying a voltage of 230 V, are removed from accidental contact by the user. By means of the decorative cap, this functional end piece can be covered decoratively in accordance with the selected design of the busbar.

### BRIEF DESCRIPTION OF THE DRAWINGS

Further features and advantages of the present invention will become clear by using the following description of preferred exemplary embodiments with reference to the appended figures, in which:

FIG. 1 shows a perspective view of a busbar system according to the invention;

FIG. 2a shows a perspective view of a strip-like insulating material surrounded by a concealment device, with supply lines accommodated therein;

FIG. 2b shows a view corresponding to FIG. 2a with the concealment device folded out;

FIG. 2c shows a view corresponding to FIG. 2a with the concealment device removed;

FIG. 3 shows a perspective view of a lamp with adaptor unit for a busbar system according to the invention;

FIG. 4a shows a schematic sectional view through a first embodiment of a concealment device according to the invention with strip-like insulating material and supply lines accommodated therein;

FIG. 4b shows a view corresponding to FIG. 4a of a second embodiment of a concealment device according to the invention with strip-like insulating material and supply lines;

FIG. 5 shows a perspective view of a further embodiment of a concealment device according to the invention with strip-like insulating material, supply lines and an end piece;

FIG. 6 shows a perspective exploded view of the concealment device according to FIG. 5 with a ceiling mounting;

FIG. 7 shows a perspective exploded view of a further embodiment of an adaptor unit for the concealment device according to FIG. 5;

FIG. 8a shows a perspective view of a further embodiment of a concealment device according to the invention with supply lines;

FIG. 8b shows a cross section through the concealment device according to FIG. 8a;

FIG. 8c shows a perspective view of the concealment device with supply lines according to FIG. 8a in the folded-out state.

### DETAILED DESCRIPTION OF PREFERRED EMBODIMENTS

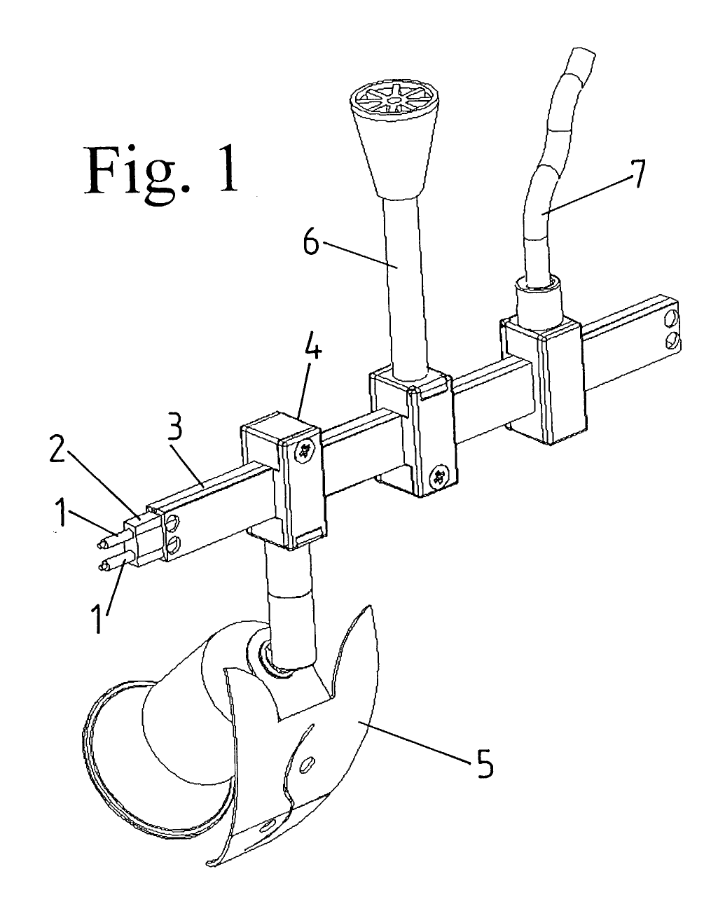

As FIG. 1 reveals, a busbar system according to the invention comprises supply lines 1 which are surrounded by a strip-like insulating material 2, which in turn is surrounded by a concealment device 3. The busbar system according to the invention further comprises adaptor units 4 which, with means to be described in more detail in the following text, make contact with the supply lines 1 through the concealment device 3 and the strip-like insulating material 2. Fitted to the adaptor units 4 are lights 5, for example in the form of a spotlight. FIG. 1 further reveals that the busbar comprising the supply lines 1, the strip-like insulating material 2 and the concealment device 3 can be fixed to the ceiling of a room by means of a ceiling support 6 engaging around this busbar. Furthermore, FIG. 1 reveals in schematic form a feed line 7, which substantially comprises a power supply cable and an adaptor unit which, like the adaptor unit 4, engage around the concealment device 3 and can make electrical contact with the supply line 1.

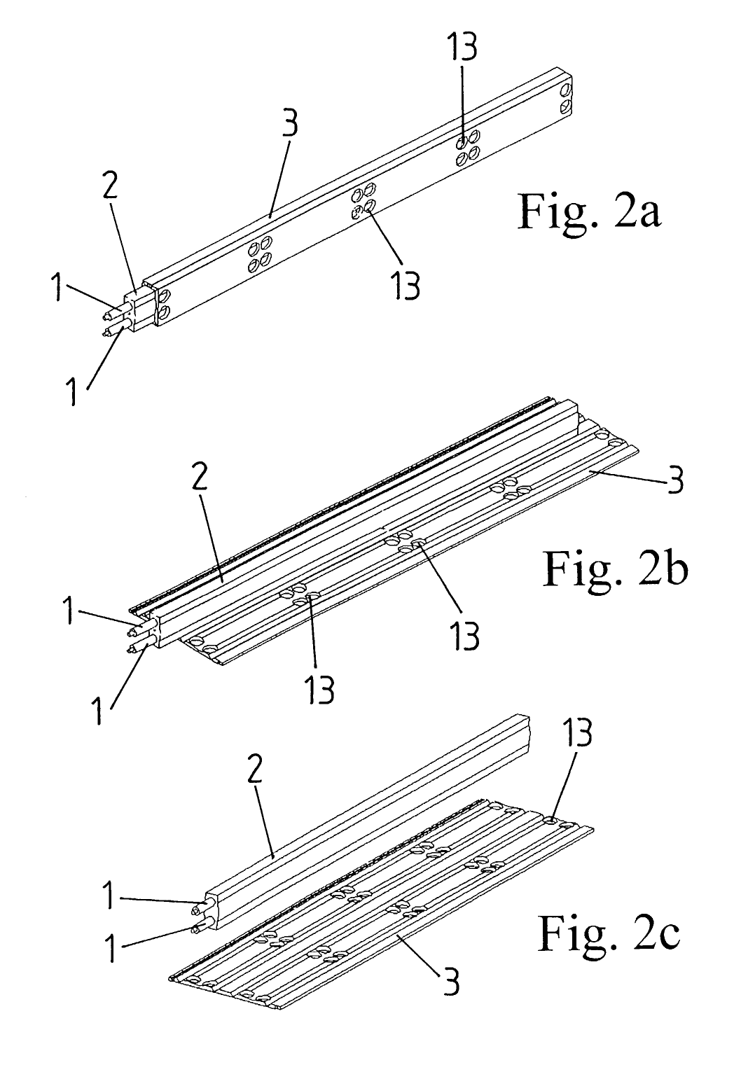

The structure of the busbar can be seen clearly from FIG. 2a to FIG. 2c. The two supply lines 1 are surrounded by the strip-like insulating material 2. In the exemplary embodiment depicted, the strip-like insulating material has a substantially rectangular cross section. The strip-like insulating material 2 is in particular of resilient design, so that the busbar can be bent as desired. FIG. 2a reveals that, when in use, the concealment device 3 surrounds the strip-like insulating material 2 completely. For this reason, the concealment device 3 that can be seen from FIG. 2a likewise has a substantially rectangular outline.

FIG. 2b and FIG. 2c reveal that the concealment device 3 can be folded apart, so that the concealment device 3 can be spread out flat. In this state, the concealment device 3 can advantageously be rolled up in its longitudinal direction.

The concealment device 3 can have any desired outer surfaces. In particular, the concealment device 3 can also be coated with thin sheets. In this case, these can also be metallic foils. Furthermore, the concealment device 3 can be provided with different colored coatings.

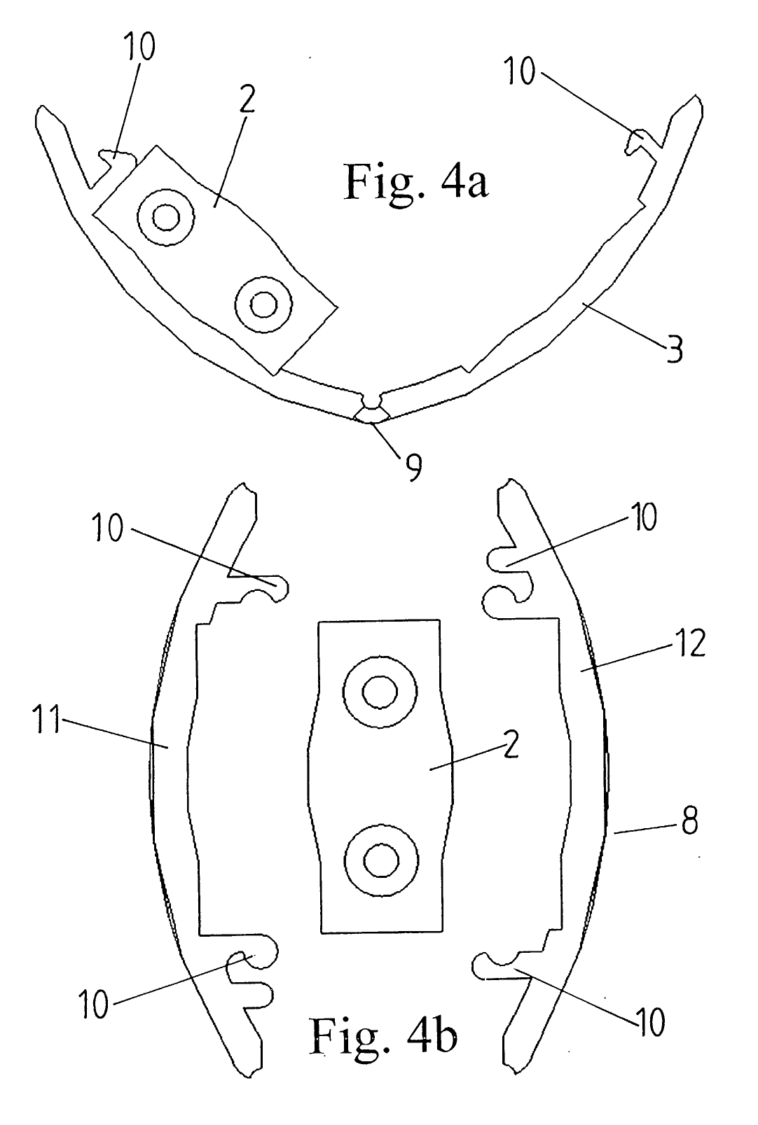

FIG. 4a and FIG. 4b reveal two different concealment devices 3, 8, which can be removed from the strip-like insulating material in different ways. The concealment device 3 depicted in FIG. 4a can be folded open and shut with the aid of a film hinge 9. With the aid of latching elements 10, which are fitted to the sides of the concealment device 3 facing away from the film hinge 9, the concealment device 3 can be clipped around the strip-like insulating material 2.

The concealment device 8 that can be seen from FIG. 4b comprises two halves 11, 12 which can be separated from each other. These can be clipped to each other around the strip-like insulating material 2 by means of mutually facing latching elements 10 in each case.

FIG. 2a further reveals that the concealment device 3 has passage openings 13. Although this cannot be seen from FIG. 4b, the concealment device 8 likewise has such passage openings 13. In the exemplary embodiment depicted, in each case groups of passage openings 13 are formed, each of these groups having four passage openings 13 which are arranged at the corners of a square. Furthermore, the passage openings 13 are formed on both sides of the concealment device 3, 8.

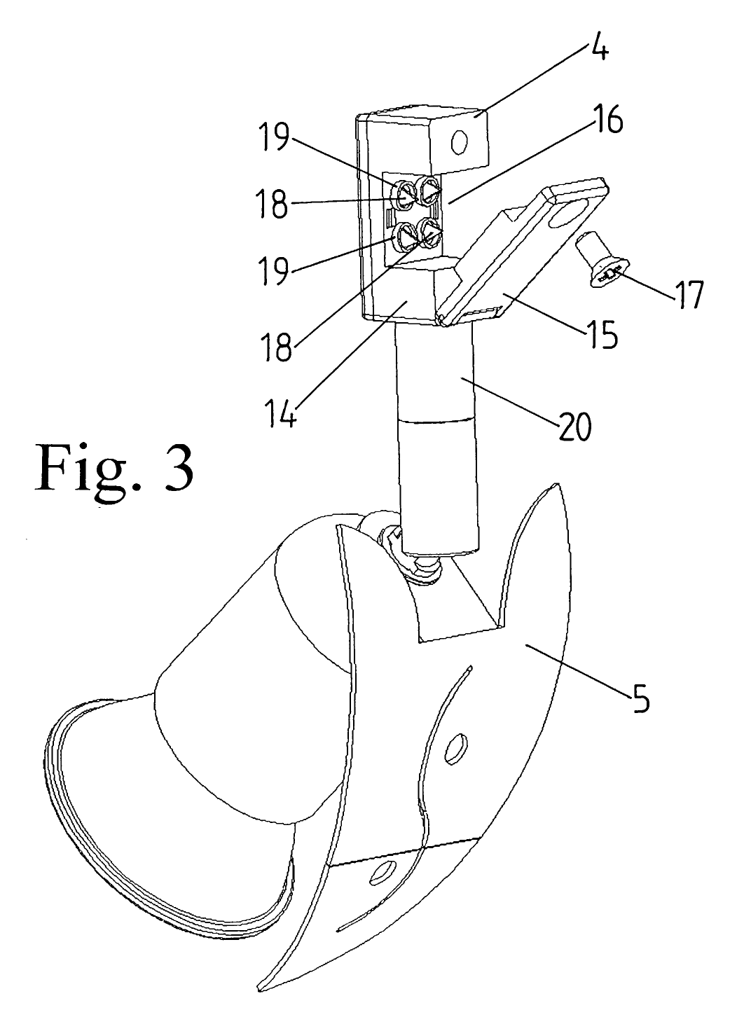

FIG. 3 reveals an adaptor unit 4 which is connected to a light 5 designed as a spotlight. The adaptor opening 4 comprises a body 14, to which a foldable cover 15 is fitted. Instead of the connection between body 14 and cover 15, which can be folded by means of a hinge, a connection is also conceivable in which the cover 15 can be hooked into corresponding hooking means belonging to the body 14. The body 14 has a substantially rectangular recess 16, into which the busbar comprising concealment device 3, 8, strip-like insulating material 2 and supply lines 1 can be introduced (in this regard, see also FIG. 1 by way of example). Following the introduction of the busbar into the recess 16, the cover 15 is folded up against the body 14 and fixed to the body 14, for example by means of a screw 17.

By means of this folding or moving the cover 15 against the body 14, contact is made with the supply lines 1 of the busbar. This is done by means of thorn-shaped contact-making elements 18, which project from the body 14 into the recess 16. In the exemplary embodiment depicted, four contact-making elements 18 are provided, which are arranged at the corners of a square. Each of the contact-making elements 18 is surrounded by an insulating ring 18, which likewise projects into the recess 16, so that only the points of the contact-making elements project forward out of the ring.

The busbar is inserted into the recess 16 in such a way that the insulating rings 19 in each case project into the passage openings 13 and through the latter. By pressing the cover 15 against the body 14, the busbar is pressed against the thorn-shaped contact-making elements 18 in such a way that the points of the latter penetrate through the strip-like insulating material into the supply lines 1 and in the latter make contact with a conductive wire, composed for example of copper.

The contact-making elements 18 are connected with the spotlight holder 20 of the light 5 designed as a spotlight via suitable connecting lines in the adaptor unit 4 and via a connection region of the adaptor unit 4. The insulating rings 19 projecting into the passage openings 13 ensure that even when there is a metallic coating on the concealment device 3, 8, no electrically conductive connection occurs between the individual contact-making elements 18.

The busbar system according to the invention may be in particular a high voltage busbar system.

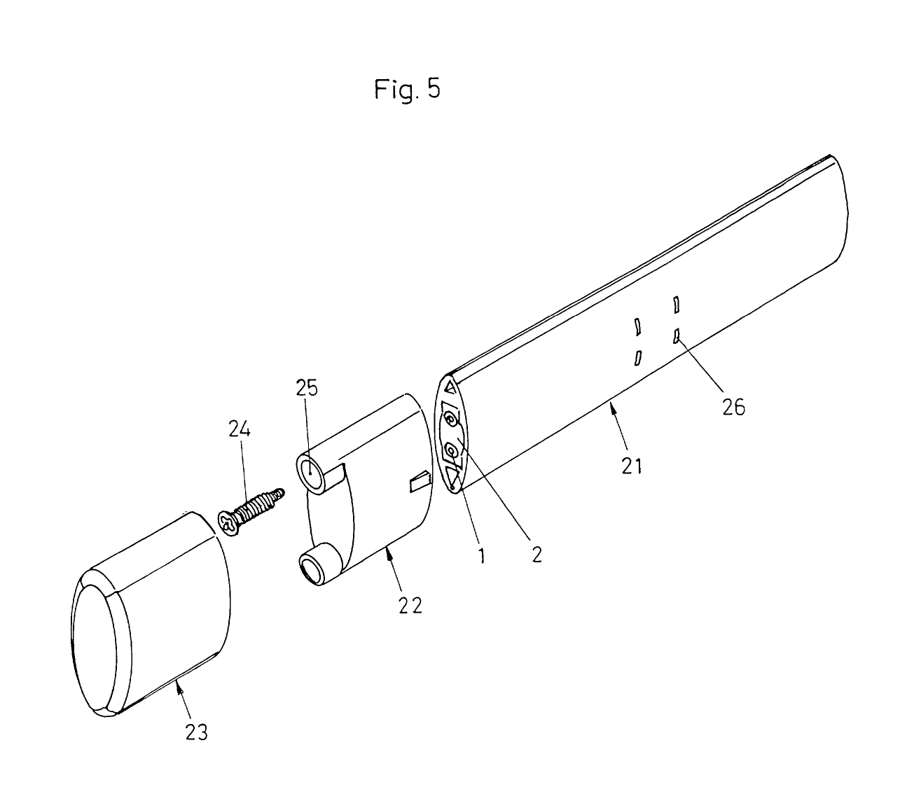

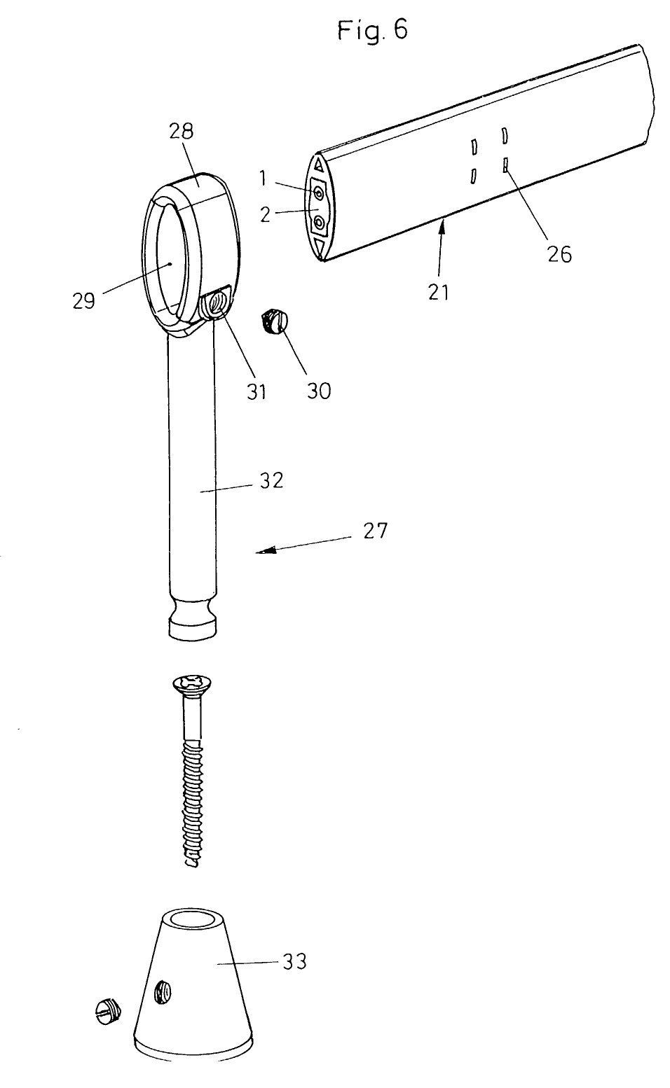

FIG. 5 and FIG. 6 reveal a further embodiment of a concealment device 21. The concealment device 21 depicted therein, as opposed to the concealment devices 3, 8, has a rounded cross section rather than a rectangular one. Also depicted in FIG. 5 is an end piece 22, which can be plugged onto the end of the busbar formed by the concealment device 21, the insulating material 20, the insulating material 2 and the supply lines 1. In addition, a decorative cap 23 can also be pushed onto the end piece 22 after the latter has been fixed to the concealment device 21. The end piece 22 can be fixed to the concealment device 21 by means of a screw 24, which can be screwed into the concealment device 21 through a hole 25 in the end piece 22.

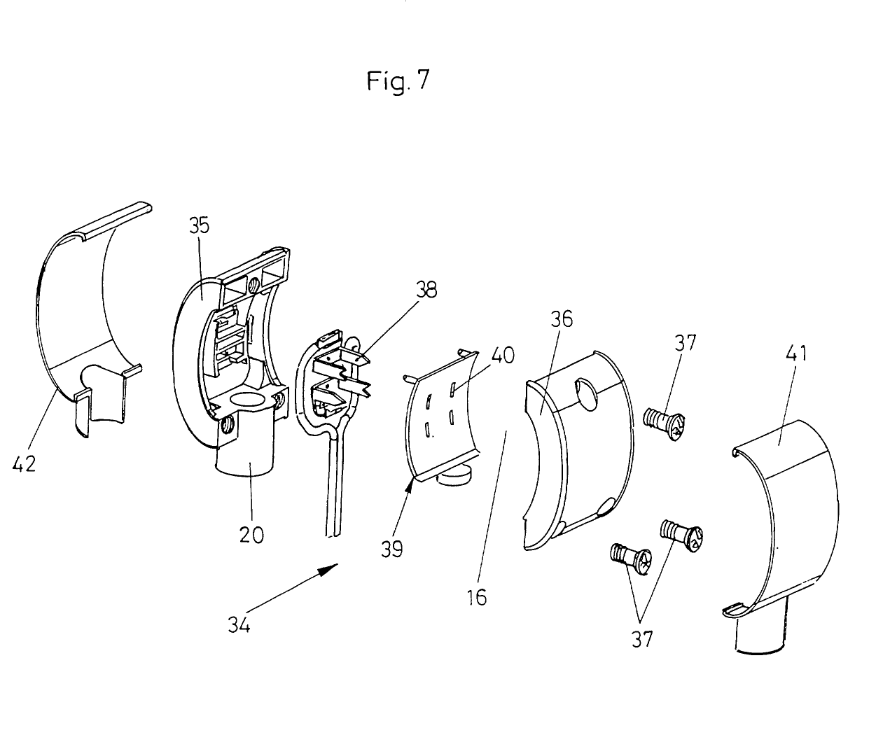

FIG. 5 further reveals that the concealment device 21 likewise has passage openings 26 but, differing to the passage openings 13, they have a slot-like cross section instead of a circular cross section. In the following text, the function of the slot-like passage openings 26 will be explained with reference to FIG. 7.

From FIG. 6, in addition to the busbar formed by the concealment device 21, the insulating material 2 and the supply lines 1, a ceiling support 27 is depicted which, at least with regard to its appearance, differs from the ceiling support 6.

In particular, the ceiling support 27 has a holding part 28 with an eye-like holding opening 29. The eye-like holding opening 29 corresponds to the cross section of the concealment device 21 in terms of its dimensions and its shape, in such a way that the concealment device 21 can be held in a fitting manner by the holding opening 29. The holding part 28 can therefore be displaced in the longitudinal direction of the busbar. By means of a grub screw 30, which can reach through a threaded hole 31 in the holding part 28, the holding part 28 and therefore the ceiling support 27 can be fixed to the busbar.

The ceiling support 27 also has a vertical support 32 which, for example, can likewise be connected by means of a grub screw to a ceiling fixing 33, which can be screwed to the ceiling of a room.

FIG. 7 reveals a further embodiment of an adaptor unit 34, which can likewise be used to hold a spotlight. The adaptor unit 34 comprises a body which comprises two halves 35, 36 which can be connected to each other, for example by means of screws 37. Fitted to the half 35 in the exemplary embodiment depicted is the start of a spotlight holder 20 which, corresponding to the adaptor unit 4 according to FIG. 3, can hold a light 5 designed as a spotlight.

In the half 35, an installation means having contact-making elements 38 can be accommodated which, as distinct from the contact-making elements 18 revealed by FIG. 3, are not surrounded by annular insulation. Instead, a cover plate 39 can be plugged onto the contact-making elements 38, having slots 40 through which the contact-making elements 38 can project. Here, the cover plate 39 can rest on the outer side of the concealment device 21 in such a way that the contact-making elements 38 project through the passage openings 26. The cover plate 39 is used for the stabilization and for the protection of the contact-making elements 38.

In the exemplary embodiment depicted in FIG. 7, the busbar, which is formed by the concealment device 21, the insulating material 2 and the supply lines 1, is accommodated by a recess 16 which, when the adaptor unit 34 is assembled, remains between the two halves 35, 36 of the body. In particular, on one side the busbar can rest on the cover plate 39 and on the other side can rest on the half 36.

FIG. 7 also reveals adaptor concealments 41, 42 which can be clipped on and whose form is matched to the halves 35, 36 of the body of the adaptor unit 34. The adaptor concealments 41, 42 can be provided with different decorations, so that in this way the optical impression of the adaptor unit can be changed in a simple way.

It is entirely possible for there to be the option of using adaptor concealments of this type for the feed lines 7 as well. There is the possibility of constructing the feed lines 7 to correspond to the adaptor unit 34. There is also the possibility of providing the holding part 28 of the ceiling support 27 with concealment parts of this type as well.

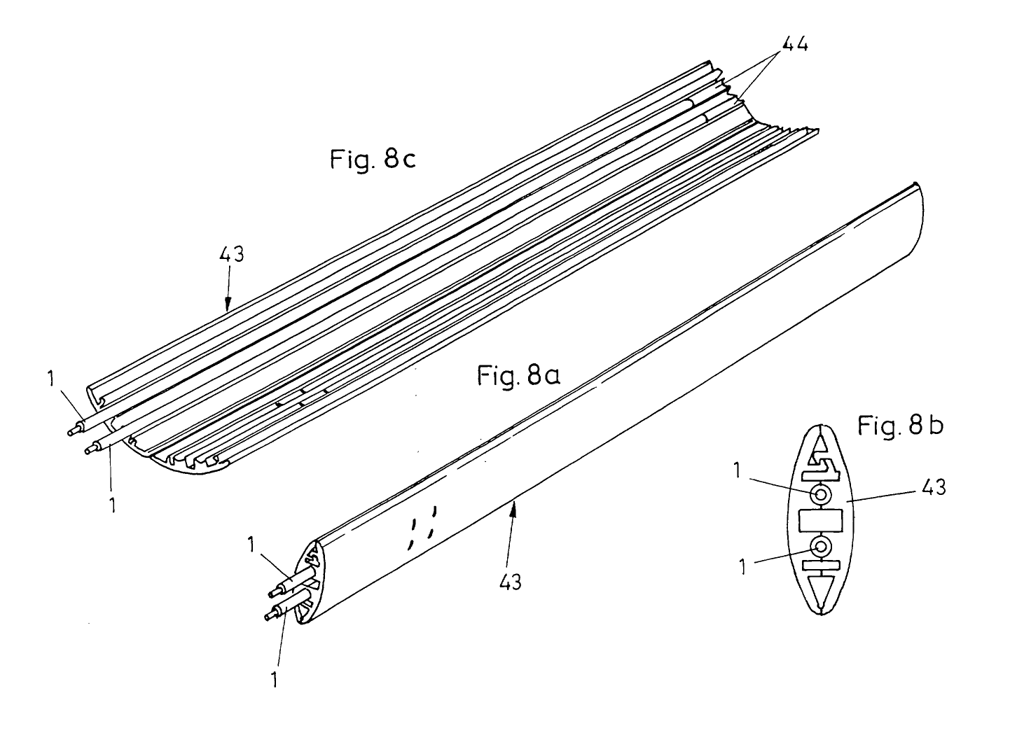

FIG. 8a to FIG. 8c reveal a further embodiment of a concealment device 43. In this exemplary embodiment, the busbar is formed only by the concealment device 43 and by supply lines 1, which can be introduced into holding grooves 44 integrally molded on the inside of the concealment device 43. In this exemplary embodiment, the strip-like insulating material 2 is omitted. In a similar way to the concealment device 3 according to FIG. 2a to FIG. 2c, the concealment device 43 can be configured so that it can be folded together and clipped together.

In all the exemplary embodiments, there is the possibility that the busbars formed from the concealment devices 3, 8, 21, 43 can be bent over in directions at right angles to their longitudinal extent. In particular, a busbar standing on edge horizontally under a ceiling of a room, as revealed by FIG. 1, for example, can also be bent over an appropriate radius in such a way that, for example, it runs vertically downward in the region of a wall. Depending on the material of the concealment device 3, 8, 21, 43, the radius enclosing the right angle of the two sections of the busbar at right angles to each other must be chosen to be larger or smaller.

1. A busbar system for lights, especially a high voltage busbar system, comprising at least one resilient busbar which has supply lines (1) which are surrounded by a resilient strip-like insulating material (2), the busbar system further comprising at least one adaptor unit (4, 34) which has contact elements (18, 38) that reach through the strip-like insulating material (2) to make electrically conductive contact with the supply lines (1), and also a connecting region for the connection to at least one lamp (5), wherein the busbar system further comprises a preferably flexible concealment device (3, 8, 21) which surrounds the strip-like insulating material (2), at least in some sections.

2. A busbar system for lights, especially a high voltage busbar system, comprising at least one resilient busbar which has supply lines (1), the busbar system further comprising at least one adaptor unit (4, 34) which has contact elements (18, 38) to make electrically conductive contact with the supply lines (1), and also a connecting region for the connection to at least one lamp (5), wherein the busbar system further comprises a preferably flexible concealment device (43) which surrounds the supply lines (1), at least in some sections.

3. The busbar system as claimed in claim 2, wherein preferably integrally molded holding grooves (44) for the supply lines (1) are provided on the inside of the concealment device (43).

4. The busbar system as claimed in claim 1, wherein the strip-like insulating material (2) is substantially completely surrounded by the concealment device (3, 8, 21).

5. The busbar system as claimed in claim 1, wherein the concealment device (3, 8, 21, 43) is coated on its outer side, in particular with a metallic coating.

6. The busbar system as claimed in claim 2, wherein the concealment device (3, 8, 21, 43) is coated on its outer side, in particular with a metallic coating.

7. The busbar system as claimed in claim 1, wherein the concealment device (3, 8, 21, 43) can be removed from the strip-like insulating material (2) and/or the supply lines (1) and transferred into a flat spread-out form.

8. The busbar system as claimed in claim 2, wherein the concealment device (3, 8, 21, 43) can be removed from the supply lines (1) and transferred into a flat spread-out form.

9. The busbar system as claimed in claim 7, wherein the concealment device (3, 8, 21, 43) can be rolled up when removed.

10. The busbar system as claimed in claim 8, wherein the concealment device (3, 8, 21, 43) can be rolled up when removed.

11. The busbar system as claimed in claim 7, wherein the concealment device (3, 21, 43) can be closed around the strip-like insulating material (2) and/or the supply lines (1) from the flat state by folding around a hinge, in particular a film hinge (9).

12. The busbar system as claimed in claim 8, wherein the concealment device (3, 21, 43) can be closed around the supply lines (1), from the flat state, by folding around a hinge, in particular a film hinge (9).

13. The busbar system as claimed in claim 1, wherein the concealment device (8) comprises two halves (11, 12) which can be connected to each other around the strip-like insulating material (2) and/or the supply lines (1).

14. The busbar system as claimed in claim 2, wherein the concealment device (8) comprises two halves (11, 12), which can be connected to each other around the supply lines (1).

15. The busbar system as claimed in claim 1, wherein passage openings (13, 26) for the contact elements (18, 38) are provided on the outer side of the concealment device (3, 8, 21, 43).

16. The busbar system as claimed in claim 2, wherein passage openings (13, 26) for the contact elements (18, 38) are provided on the outer side of the concealment device (3, 8, 21, 43).

17. The busbar system as claimed in claim 15, wherein the contact elements (18) are surrounded by insulating rings (19), which can engage in the passage openings (13) in such a way that the contact elements (18) can be led through the passage openings (13) while being electrically insulated from the concealment device (3, 8).

18. The busbar system as claimed in claim 16, wherein the contact elements (18) are surrounded by insulating rings (19), which can engage in the passage openings (13) in such a way that the contact elements (18) can be led through the passage openings (13) while being electrically insulated from the concealment device (3, 8).

19. The busbar system as claimed in claim 1, wherein the adaptor unit (4, 34) has a body (14) with a recess (16), into which the busbar can be introduced, the contact elements (18) projecting from the body (14) into this recess (16).

20. The busbar system as claimed in claim 2, wherein the adaptor unit (4, 34) has a body (14) with a recess (16), into which the busbar can be introduced, the contact elements (18) projecting from the body (14) into this recess (16).

21. The busbar system as claimed in claim 19, wherein the adaptor unit (4) comprises a cover (15) which, as a result of being fitted and fixed to the body (14), can ensure the making of secure contact with a busbar introduced into the recess (16).

22. The busbar system as claimed in claim 20, wherein the adaptor unit (4) comprises a cover (15) which, as a result of being fitted and fixed to the body (14), can ensure the making of secure contact with a busbar introduced into the recess (16).

23. The busbar system as claimed in claim 19, wherein the adaptor unit (34) comprises a body with two halves (35, 36) that can be connected to each other, between which the recess (16) can be formed.

24. The busbar system as claimed in claim 20, wherein the adaptor unit (34) comprises a body with two halves (35, 36) that can be connected to each other, between which the recess (16) can be formed.

25. The busbar system as claimed in claim 19, wherein the adaptor unit (34) comprises a cover plate (39) which has slots (40) for the contact elements (38) to pass through.

26. The busbar system as claimed in claim 20, wherein the adaptor unit (34) comprises a cover plate (39) which has slots (40) for the contact elements (38) to pass through.

27. The busbar system as claimed in claim 1, wherein the busbar system comprises concealment elements which are able to conceal individual parts of the busbar system.

28. The busbar system as claimed in claim 2, wherein the busbar system comprises concealment elements which are able to conceal individual parts of the busbar system.

29. The busbar system as claimed in claim 27, wherein the concealment elements are formed as adaptor concealments (41, 42) which are able to conceal the adaptors (4, 34).

30. The busbar system as claimed in claim 28, wherein the concealment elements are formed as adaptor concealments (41, 42) which are able to conceal the adaptors (4, 34).

31. The busbar system as claimed in claim 27, wherein the concealment elements are used to conceal ceiling supports (6, 27) or feed lines (7).

32. The busbar system as claimed in claim 28, wherein the concealment elements are used to conceal ceiling supports (6, 27) or feed lines (7).

33. The busbar system as claimed in claim 27, wherein the concealment elements can be clipped onto the parts of the busbar system to be concealed or can be latched thereto.

34. The busbar system as claimed in claim 28, wherein the concealment elements can be clipped onto the parts of the busbar system to be concealed or can be latched thereto.

35. The busbar system as claimed in claim 1, wherein the busbar system comprises at least one end piece (22), which can be fitted to one end of the busbar, in particular screwed thereto.

36. The busbar system as claimed in claim 2, wherein the busbar system comprises at least one end piece (22), which can be fitted to one end of the busbar, in particular screwed thereto.

37. The busbar system as claimed in claim 35, wherein a decorative cap (23) can be pushed onto the end piece (22).

38. The busbar system as claimed in claim 36, wherein a decorative cap (23) can be pushed onto the end piece (22).
